(19) United States
(12) Patent Application Publication
(10) Pub. No.: US 2021/0214081 A1
(43) Pub. Date: Jul. 15, 2021

(54) Accommodation and Deployment Device for Payloads on a Flying Machine

(71) Applicant: Airbus Defence and Space GmbH, Taufkirchen (DE)

(72) Inventor: Ralf Schlüter, Taufkirchen (DE)

(73) Assignee: Airbus Defence and Space GmbH, Taufkirchen (DE)

(21) Appl. No.: 17/147,814

(22) Filed: Jan. 13, 2021

(30) Foreign Application Priority Data
Jan. 14, 2020 (DE) 20 2020 100 183.3

(51) Int. Cl. B64D 1/06

(52) U.S. Cl. CPC B64D 1/06

(57) ABSTRACT

A device for accommodating and deploying at least one payload on a flying machine includes at least one housing. The housing includes at least two opposite first side surfaces which extend over at least a portion of a length of a payload to be accommodated. The payload to be accommodated is releasably held between the two first side surfaces of the housing. The housing is at least partially arranged in a cavity on an outer surface of a flying machine. The cavity includes at least one outwardly open first opening, and the housing can be at least partially moved out of the cavity for deploying and/or receiving the payload to be accommodated.

### FIELD OF THE INVENTION

Various embodiments generally relate to a device for accommodating and deploying payloads on a flying machine.

### BACKGROUND OF THE INVENTION

Today's dropped and launched payloads or ammunition are carried either on external payload carriers or weapon carriers or in internal, large-scale weapons bays on the aircraft. In the first case, the carrying devices and payloads, such as weapons, constitute an aerodynamic and radar signature-related deterioration of the aircraft or flying machine. In the case of today's weapons bays, the aerodynamic and radar signature-related disadvantage is removed as long as the bays remain closed. When opening the weapons bays, however, the disadvantages described above also occur. Opening the bays also delays the deployment of weapons. The carrying and launching systems available today do not usually offer the possibility of launching weapons which are integrated into the aerodynamics and radar signatures with the same short time delay as weapons mounted on external load carriers.

### BRIEF SUMMARY OF THE INVENTION

An aspect of the invention may provide an accommodation and deployment device for flying machines which improves the above disadvantages.

According to an embodiment, a device for accommodating and deploying at least one payload on an aircraft has at least one housing, wherein the housing has at least two opposite first side surfaces. The two opposite side surfaces extend over at least a partial region of the length of a payload to be accommodated. The payload to be accommodated is removably held between the first two side surfaces of the housing. The housing is at least partially arranged in a cavity on an outer surface of a flying machine. The cavity has at least one externally open first opening. The housing can be at least partially moved out of the cavity for launching and/or receiving the payload to be accommodated.

An aspect of the invention is based on the idea of providing an accommodation and deployment device, which may also be referred to as a carrying and deploying device, for a flying machine or aircraft in which the payload can be deployed without significantly influencing the radar signature of the aircraft. For this purpose, the launching device has a housing, hereinafter also referred to as a tunnel launcher, which preferably forms the aerodynamic contour of the flying machine or of a fighter aircraft on one side, while the rest of the carrying and launching device is housed in the aircraft structure in cavities or weapons bays adapted to the weapon in shape and size. The housing or the tunnel launcher is used similarly to so-called drop launchers at the moment of launching of the payload or the round from the aircraft or the strake and allows the launching of the payload or the weapon using the driving force of the drive of the payload or the weapon while deflecting the exhaust jet away from the flying machine or the aircraft.

According to a preferred embodiment of the device, the cavity has a closing device. By means of the closing device, the cavity can be sealed aerodynamically and/or in relation to radar radiation when launching or extracting the at least one payload from the housing. This has the advantage of improving the radar signature of the aircraft.

According to a preferred embodiment of the device, the housing has at least one further side surface. The further side surface connects the two first side surfaces of the housing in the area of the lateral edge of the first side surface lying in the direction of the outer surface of the flying machine. The outer surface of the flying machine can be sealed aerodynamically and/or in relation to radar radiation by means of the further side surface of the housing when the housing is fully housed in the cavity. The first two side surfaces and the further side surface thus preferably form three side surfaces of a housing.

According to a further preferred embodiment, the housing may have a further side surface, which at least partially connects the three side surfaces together at the end and forms a fourth side of the housing. For example, the further side surface at the end is used, when launching a payload such as a guided missile, to give this a forward-directed acceleration impulse to mitigate the short-term aerodynamic resistance of the delivery device and preferably to give a further impulse away from the trajectory of the missile.

According to a preferred embodiment of the device, at least one of the side surfaces has at least one closable pressure relief opening. The pressure relief opening can be either on one of the side surfaces or the further side surface arranged at the end. The task of the pressure relief opening is, on the one hand, to guide the exhaust gases away from the flying machine when a payload is ejected or launched, such as a guided missile. Furthermore, the pressure relief opening is used to convey an acceleration impulse to the payload to be launched.

According to a preferred embodiment of the device, the housing has a rail-guided holding device arranged on the first side surfaces. By means of the holding device, at least one payload to be accommodated is releasably held by the accommodation device at least on two sides. The holding device allows the payload to be accommodated and enables launching of the payload using the guidance of the rails of the holding device.

According to a preferred embodiment of the device, the accommodation device is designed to accommodate a number of payloads. After releasing the payload, such as a weapon, the housing or tunnel launcher can be moved back to its strake position and another payload, for example a weapon, is fed in internally. This has the advantage that multiple payloads can be carried in the aircraft using an accommodation and deployment device.

According to a preferred embodiment of the device, the rail-guided accommodation device has at least two retaining rails. The retaining rails are used to hold the payload preferably on two opposite side surfaces and to guide it during the launching. Preferably, the payload is designed here so that at least two opposite side surfaces of the payload have grooves or the like which correspond to the retaining rails.

According to a preferred embodiment of the device, the retaining rail has a plurality of regularly arranged retaining elements. In order to facilitate the accommodation of the payload in the retaining rails, the retaining rails may be formed by preferably at least partially regularly arranged retaining elements or retaining blocks. The retaining elements can be guided, for example, as sliding blocks or as guide rollers. These sliding solutions are designed variably to accommodate different sized payloads.

According to a preferred embodiment of the device, the distance between the at least two retaining rails of the rail-guided accommodation device and/or the position of the at least two retaining rails in the cavity can be controllably varied. For accommodating payloads with different sizes or diameters, the distance of the retaining rails can preferably be varied. This also has the advantage that the distance of the retaining rails can be extended, for example, to accommodate the payload.

According to a preferred embodiment of the device, the cavity has a magazine for accommodating a plurality of payloads and the payloads contained in the magazine can be fed into the housing by means of a feed mechanism. Depending on the realization of the carrying concept, it may be possible to stow more than one payload or weapon in the bay. After releasing the payload or the weapon, the tunnel launcher can be closed back in its strake position and another internal payload or weapon can be fed in internally.

According to a preferred embodiment of the device, the plurality of payloads can be launched sequentially or in pairs by means of the rail-guided accommodation device.

Furthermore, the object is achieved by a payload for accommodating and deploying by an aircraft with an elongated payload body, with at least one outer surface which has at least two elongated recesses extending over a portion of the length of the payload body. The payload can be accommodated in a previously described device.

By the accommodation and deployment device described here, substantially the same aerodynamic and radar signature-related advantages are achieved as with the use of non-specific large weapons bays, but without having the disadvantage of delayed firing/dropping by opening a bay cover and without corresponding open covers being able to negatively affect the radar signature or the aerodynamics. At the same time, the tunnel concept allows the accommodation of existing payloads, such as weapons, without the need for specific new developments for them.

### BRIEF DESCRIPTION OF THE DRAWINGS

In the drawings, the same reference characters generally refer to the same parts across the different views. The drawings are not necessarily true to scale; instead, emphasis is generally placed on illustrating the principles of the invention. In the following description, various embodiments of the invention are described with reference to the following drawings, in which:

FIG. 1 shows a first embodiment of a device for accommodation and deployment of a payload on a flying machine;

FIG. 2 shows another embodiment of a device for accommodation and deployment of a plurality of payloads on a flying machine; and

FIG. 3 shows a further representation of an embodiment of a device for accommodation and deployment of a plurality of payloads on a flying machine.

### DETAILED DESCRIPTION

The following detailed description refers to the accompanying drawings, which show for explanation specific details and embodiments in which the invention can be put into practice.

The word “exemplary” is used herein with the meaning “serving as an example, case or illustration”. Any embodiment or embodiment described herein as “exemplary” shall not necessarily be interpreted as preferred or advantageous over other embodiments or configurations.

In the following detailed description, reference is made to the accompanying drawings, which form part of this description and in which specific embodiments in which the invention can be executed are shown for illustrative purposes. In this respect, directional terminology such as “top”, “bottom”, “front”, “back”, etc. is used with reference to the orientation of the described figure(s). Since components of embodiments can be positioned in a number of different orientations, directional terminology is used for illustrative purposes and is in no way restrictive. It is understood that other embodiments can be used, and structural or logical changes can be made without deviating from the scope of protection of the present invention. It is understood that the characteristics of the various exemplary embodiments described herein can be combined with each other, unless specifically indicated otherwise. The following detailed description is therefore not to be taken in a restrictive sense, and the scope of protection of the present invention is defined by the attached claims.

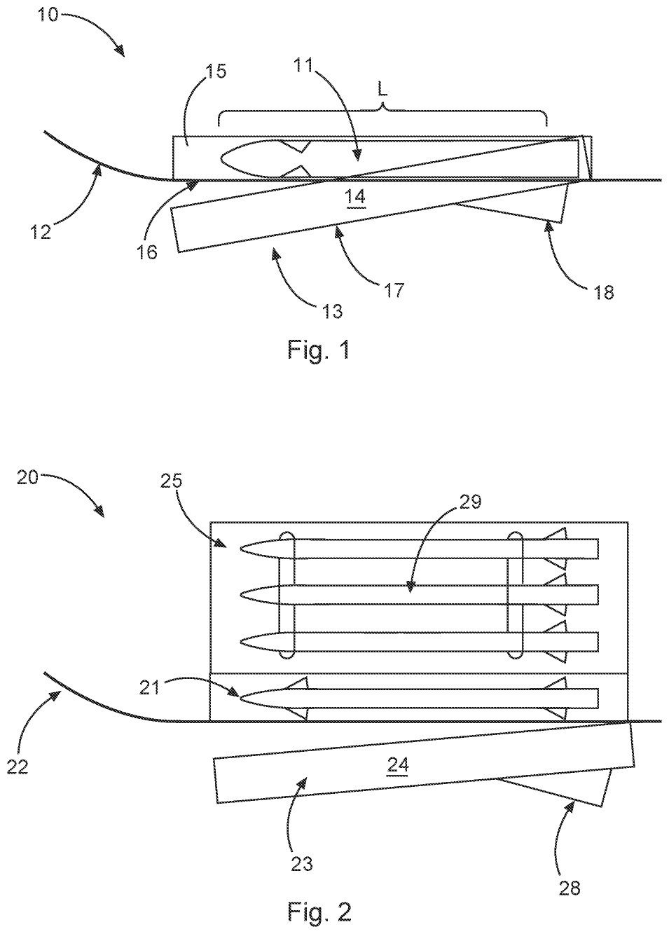

FIG. 1 shows a first embodiment of a device 10 for accommodating and deploying a payload 11 on a flying machine 12. The device 10 has a housing 13 with two opposite first side surfaces 14—in the figure only one of the two side surfaces 14 is visible due to the two-dimensional representation. The side surfaces 14 extend over at least a portion of the length L of the payload 11. In the embodiment shown in FIG. 1, the payload 11 shown in the housing 13 is smaller than would be possible in principle due to the dimension. The payload 11 is detachably held between the first two side surfaces 14 of the housing 13. In a retracted state, the housing 13 is arranged in a cavity 15 on an outer surface of the flying machine 12. The cavity 15 has an externally open first opening 16. The housing 13 is at least partially movable out of the cavity 15 for deploying and/or receiving the payload 11 to be accommodated. FIG. 1 also shows, in addition to the retracted state, the state of the housing 13 which is forced out or pushed out of the strake. In the embodiment of the device 10 shown in FIG. 1, the housing 13 has a pressure relief opening 18 for discharging the exhaust gas jet. In this embodiment the pressure relief opening 18 is arranged on a further side surface 17 which connects the first two side surfaces 14 at the bottom.

FIG. 2 shows a further embodiment of a device 20 for accommodation and deployment of a plurality of payloads 21, 21′ on a flying machine 22. A first payload 21 is arranged in the housing 23. Further payloads 21′ are arranged in a magazine 29 in the cavity 25, via which the further payloads 21′ can be fed into the housing 23 after deploying the first payload 21. The housing 23 also has a pressure relief opening 28 at the bottom of the side surfaces 24.

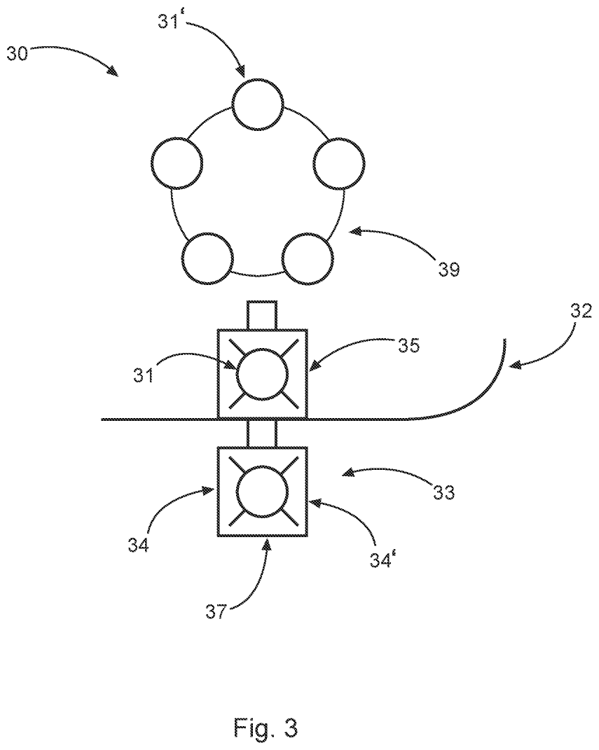

FIG. 3 shows a further representation of an embodiment of a device 30 for accommodation and deployment of a plurality of payloads 31, 31′ on an aircraft 32. Here the device 30 has a round magazine 39, in which further payloads 31′ are arranged. The further payloads 31′ can be reloaded into the housing 33 after the deployment of the first payload 31. In the embodiment of the device 30 shown in FIG. 3, the housing 33 has two first side surfaces 34, 34′ and a further side surface 37 connecting the first two side surfaces 34, 34′.

Although the invention has been shown and described primarily with reference to certain embodiments, it should be understood by those who are familiar with the subject area that numerous changes in design and detail can be made to it without deviating from the nature and scope of the invention as defined by the attached claims. The scope of the invention is thus determined by the attached claims, and it is therefore intended that all changes which fall within the literal meaning or the equivalence range of the claims are included.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE CHARACTER LIST

10, 20, 30 Device
11, 21, 21′, 31, 31′ Payload
12, 22, 32 Flying machine (or aircraft)
13, 23, 33 Housing
14, 24, 34, 34′ First side surfaces
15, 25, 35 Cavity
16 Opening
17, 37 Further side surface
18, 28 Pressure relief opening
29, 39 Magazine

1. A device for accommodating and deploying at least one payload on a flying machine, comprising:
at least one housing,
wherein the housing has at least two opposite first side surfaces which extend over at least a portion of the length of a payload to be accommodated,
wherein the payload to be accommodated is releasably held between the first two side surfaces of the housing,
wherein the housing is at least partially arranged in a cavity on an outer surface of a flying machine,
wherein the cavity has at least one outwardly open first opening, and
wherein the housing is configured to be at least partially moved out of the cavity for deploying and/or receiving the payload to be accommodated.

2. The device according to claim 1, wherein the cavity has a closing device by which the cavity is configured to be sealed aerodynamically and/or in relation to radar radiation at the time of deployment or extraction of at least one payload from the housing.

3. The device according to claim 1, wherein the housing has at least one further side surface which connects the two first side surfaces of the housing in the area of the side edge of the first side surfaces located in the direction of the outer surface of the flying machine and wherein the outer surface of the flying machine is configured to be sealed aerodynamically and/or in relation to radar radiation by the further side surface of the housing when the housing is fully housed in the cavity.

4. The device according to claim 1, wherein at least one of the side surfaces has at least one closable pressure relief opening.

5. The device according to claim 1,
wherein the housing has a rail-guided accommodation device arranged on the first side surfaces and
wherein at least one payload to be accommodated is removably held at least on two sides by the accommodation device.

6. The device according to claim 5, wherein the rail-guided accommodation device is configured to accommodate a plurality of payloads.

7. The device according to claim 5, wherein the rail-guided accommodation device has at least two retaining rails.

8. The device according to claim 7, wherein the retaining rail has a plurality of regularly arranged retaining elements.

9. The device according to claim 8, wherein the distance between the at least two retaining rails of the rail-guided accommodation device or the position of the at least two retaining rails in the cavity is configured to be changed controllably.

10. The device according to claim 5, wherein the cavity has a magazine for the accommodation of a plurality of payloads and the payloads contained in the magazine are configured to be fed into the housing by a feed mechanism.

11. The device according to claim 10, wherein the plurality of payloads is configured to be deployed sequentially or in pairs by the rail-guided accommodation device.

12. A payload for accommodation and deployment on a flying machine, comprising:
an elongated payload body, with at least one outer surface which has at least two elongated recesses extending over a portion of the length of the payload body and which is configured to be accommodated in a device according to claim 1.
